(19) United States
(12) Patent Application Publication
(10) Pub. No.: US 2026/0277082 A1
(43) Pub. Date: Sep. 17, 2026

(54) SUPPORT ASSEMBLY AND PHOTOGRAPHY SUPPORT FRAME

(71) Applicant: SHENZHEN LEQI INNOVATION CO., LTD., SHENZHEN (CN)

(72) Inventors: LIANG GUO, SHENZHEN (CN); SHAORUI TANG, SHENZHEN (CN); JIANLEI ZHANG, SHENZHEN (CN)

(21) Appl. No.: 19/565,603

(22) Filed: Mar. 13, 2026

(30) Foreign Application Priority Data
Mar. 14, 2025 (CN) 202520473659.2

(51) Int. Cl. G03B 17/56; F16M 11/28

(52) U.S. Cl. CPC G03B 17/561; F16M 11/28; F16M 2200/027

(57) ABSTRACT

The present disclosure provides a support assembly and a photography support frame. The support assembly includes a telescopic tube assembly including an outer tube, a first inner tube disposed within the outer tube, and a second inner tube disposed within the first inner tube. The first inner tube is axially slidable relative to the outer tube, and the second inner tube is axially slidable relative to the first inner tube. The assembly further includes a first locking assembly with a locking sleeve connected to the outer tube, a gap being defined between the sleeve and the second inner tube. The assembly further includes a pressing assembly connected to the first inner tube, and the pressing assembly has an inner wall closely contacting the second inner tube and a side wall embedded into the gap.

### CROSS-REFERENCE TO RELATED APPLICATION

This application is based on and claims priority to China Patent Application No. 2025204736592, filed on Mar. 14, 2025, the entire contents of which are incorporated herein by reference.

### FIELD

The present disclosure relates to the technical field of photography and videography, especially relates to a support assembly and a photography support frame.

### BACKGROUND

With the growing demand for photography and videography, a wide variety of photographic auxiliary devices continue to emerge. As one of the common auxiliary devices, a photography support frame can provide stable support for cameras or other shooting devices, effectively reducing image jitter caused by handheld shooting or unstable platforms.

At present, common photography support frame available mainly include monopods, tripods, and some specialized support structures for particular uses. These products commonly realize multi-angle and multi-height support adjustment for shooting equipment through the deployment and retraction of multiple support assemblies. In related art, support assemblies mostly employ a multi-section rod structure, realize height or angle adjustment through the telescopic cooperation between rods, and achieve fixation by means of mechanical buckles, thread locking, lever mechanisms or the like.

However, while achieving secure clamping, these conventional locking assemblies often suffer from issues such as complex structure, high manufacturing process requirements, and elevated costs.

### SUMMARY

The main purpose of the present disclosure is to propose a support assembly and a photography support frame, aiming to solve the technical problems of structural complexity, high manufacturing precision requirements, and excessive costs in current locking assemblies.

To achieve the above purpose, the present disclosure proposes a support assembly configured to support equipment. The support assembly includes a telescopic tube assembly. The telescopic tube assembly includes an outer tube, a first inner tube disposed within the outer tube and being capable of sliding relative to the outer tube in an axial direction, and a second inner tube disposed within the first inner tube and being capable of sliding relative to the first inner tube in the axial direction. The support assembly further includes a first locking assembly including a locking sleeve and a pressing assembly. The locking sleeve is connected to one end of the outer tube, and a gap is defined between the locking sleeve and the second inner tube. The pressing assembly is connected to one end of the first inner tube, and moves in conjunction with the first inner tube. An inner wall of the pressing assembly is configured to closely contact the second inner tube, and a side wall of the pressing assembly embeds into the gap between the locking sleeve and the second inner tube.

In some embodiments, an inner wall of the locking sleeve and an outer wall of the pressing assembly are both featured to be tapered.

In some embodiments, the pressing assembly includes a first bushing and a plurality of pressing blocks. The first bushing is connected to one end of the first inner tube, a peripheral wall of the first bushing defines a plurality of mounting notches, and the plurality of mounting notches are spaced apart along a circumferential direction of the first bushing. Each of the mounting notches is arranged with at least one pressing block. The pressing blocks are configured to abut against the second inner tube under a pressing action from the locking sleeve.

In some embodiments, the support assembly further includes a third inner tube which is disposed within the second inner tube, a fourth inner tube which is disposed within the third inner tube, and a second locking assembly which is disposed at one end of both the second inner tube and the third inner tube. A structure of the second locking assembly is identical to that of the first locking assembly.

In some embodiments, the support assembly further includes a driving mechanism. The driving mechanism includes a first driving member which is disposed at the other end of the outer tube. The first driving member includes an actuating end which is extended into the outer tube and is connected to the other end of the first inner tube, and the first driving member is configured to drive the first inner tube to move.

In some embodiments, the first driving member includes a mounting housing which has a first cavity defined therein, a top wall of the mounting housing is defined with a first opening, and a bottom wall of the mounting housing is defined with a second opening. The first driving member also includes a piston assembly including a fixing seat and a piston sleeve. The fixing seat is mounted at the first opening and at least partially extended into the first cavity.The piston sleeve is slidably disposed within the first cavity and nested over a part of the fixing seat that extends into the first cavity, and a second cavity for receiving fluid is defined between the fixing seat and the piston sleeve. An end of the piston sleeve opposite to the fixing seat passes through the second opening and is connected to the one end of the first inner tube.

In some embodiments, the piston assembly further includes an elastic member disposed within the first cavity, and the elastic member is configured to flexibly support the piston sleeve.

In some embodiments, the driving mechanism further includes a second driving member which moves in conjunction with the first driving member. The second driving member is disposed at the end of the second inner tube. The second driving member includes an actuating end that extends into the second inner tube and is connected to another end of the third inner tube. The second driving member is configured to drive the third inner tube to move axially relative to the second inner tube, and a structure of the second driving member is identical to that of the first driving member.

In some embodiments, the fixing seat defines a third opening communicated with the second cavity, and a side wall of the piston sleeve defines a fourth opening communicated with the second cavity. The third opening is configured to couple to an operating component, and the fourth opening is coupled to the second driving member via a fluid pipeline.

The present disclosure also provides a photography support frame, which includes an operating component, a bearing seat, and a plurality of support assemblies according to the aforementioned embodiments. The bearing seat is connected to the telescopic tube assemblies of the plurality of support assemblies, and the bearing seat is configured to mount photographic equipment. The operating component is connected to the driving mechanism of each of the support assemblies, and the operating component is configured to output a driving force to the driving mechanism of each of the support assemblies.

In the technical solution of the present disclosure, axial movement of the first inner tube drives the pressing assembly and causes a side wall thereof to extend naturally into a predefined gap between the locking sleeve and the second inner tube to achieve a stable locking effect. This design eliminates the complex components found in conventional support assembly, thus an overall structure is simpler and more compact, while also lowers the required machining precision for the parts. Furthermore, due to the pressing assembly moving in conjunction with the first inner tube, the assembly process for the entire support assembly becomes straightforward and intuitive, requiring no complicated assembly steps. Consequently, production efficiency is improved and manufacturing cost is reduced.

### BRIEF DESCRIPTION OF THE DRAWINGS

Implementations of the present disclosure will now be described, by way of embodiment, with reference to the attached FIG.s. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an overall structural diagram of a support assembly according to an embodiment of the present disclosure.

FIG. 2 is a front view of the support assembly according to an embodiment of the present disclosure.

FIG. 3 is a cross-sectional view taken along line E-E of FIG. 2.

FIG. 4 is an enlarged view of the portion labeled A in FIG. 3.

FIG. 5 is an exploded view of a first locking assembly according to an embodiment of the present disclosure.

FIG. 6 is an enlarged view of the portion labeled B in FIG. 3.

FIG. 7 is an enlarged view of the portion labeled C in FIG. 3.

FIG. 8 is an exploded view of the first driving member according to an embodiment of the present disclosure.

FIG. 9 is an enlarged view of the portion labeled D in FIG. 3.

FIG. 10 is a schematic cross-sectional view of of the support assembly according to an embodiment of the present disclosure.

### REFERENCE NUMERALS

100, telescopic tube assembly; 110, outer tube; 111, first inner tube; 112, second inner tube; 201, first locking assembly; 210, locking sleeve; 211, pressing assembly; 212, first bushing; 212a, mounting notch; 213, pressing block; 113, third inner tube; 114, fourth inner tube; 202, second locking assembly; 301, first driving member; 302, mounting housing; 321, first cavity; 302a, first opening; 302b, second opening; 310, piston assembly; 311, fixing seat; 311c, third opening; 312, piston sleeve; 311d, fourth opening; 322, second cavity; 313, elastic member; 320, second driving member; 400, fluid pipeline.

The realization of the aim, functional characteristics, advantages of the present disclosure are further described specifically with reference to the accompanying drawings and embodiments.

### DETAILED DESCRIPTION

The technical solutions in the embodiments of the present disclosure will be clearly and completely described below in conjunction with the accompanying drawings. It is obvious that the described embodiments are only part of the embodiments of the present disclosure, not all of them. Based on the embodiments of the present disclosure, all other embodiments obtained by those of ordinary skill in the art without creative work shall fall within the scope of protection of the present disclosure.

It should be noted that all directional indications (such as up, down, left, right, front, back, etc.) in the embodiments of the present disclosure are only used to explain the relative positional relationship, movement conditions, etc., between the components under a specific posture (as shown in the accompanying drawings). If the specific posture changes, the directional indications will also change accordingly.

It should also be noted that when an element is referred to as being “fixed to” or “disposed on” another element, it can be directly on the other element or there may be an intervening element. When an element is referred to as being “connected to” another element, it can be directly connected to the other element or there may be an intervening element.

In addition, descriptions involving “first”, “second”, etc., in the present disclosure are for descriptive purposes only and shall not be construed as indicating or implying their relative importance or implicitly indicating the number of indicated technical features. Thus, features defined with “first”, “second” may explicitly or implicitly include at least one such feature. In addition, the technical solutions of the various embodiments can be combined with each other, but must be based on the realization by those of ordinary skill in the art. When a combination of technical solutions is contradictory or cannot be realized, it shall be considered that such a combination of technical solutions does not exist and is not within the scope of protection claimed by the present disclosure.

With the growing demand for photography, videography, and other professional image creation, the importance of stable supporting devices has become increasingly prominent. As a core auxiliary device for professional shooting, a photography support frame can provide a stable and reliable supporting platform for devices such as cameras and video cameras, effectively eliminate the inevitable shaking issues in handheld shooting and significantly improve imaging quality.

At present, photographic support systems available on the market mainly include monopods, tripods, and specialized supporting devices for specific scenarios. These products generally adopt a multi-section telescopic support leg structure, realizing multi-dimensional stable support for shooting equipment through the extension, retraction, and angle adjustment of the support legs. Most of the support leg assemblies adopt a multi-stage sleeve design, complete height adjustment by means of telescopic fit between sleeves, and achieve position fixation by combining mechanisms such as friction locking, threaded fastening, or quick-release buckles.

However, while these traditional locking structures provide reliable locking functions, they often suffer from issues such as complex mechanisms, a large number of components, high requirements for machining accuracy, and high production costs. Further more, it is difficult to balance operational convenience and locking stability. To solve the above problems, the present disclosure proposes a support assembly with a simple structure, convenient operation, and reliable locking performance.

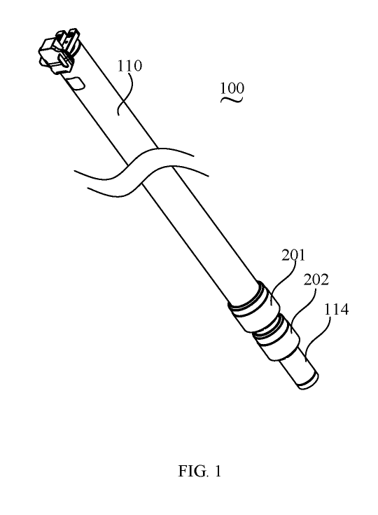

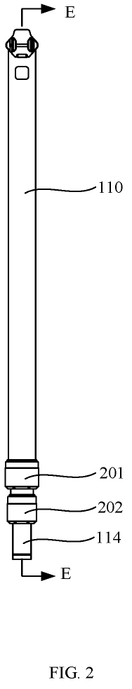

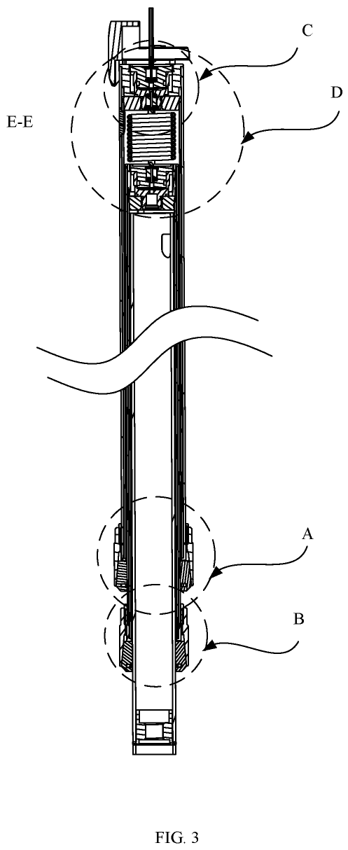

Please referring to FIGS. 1 to 5, an embodiment of the present disclosure provides a support assembly configured to support equipment, and the support assembly includes a telescopic tube assembly 100.

The telescopic tube assembly 100 includes an outer tube 110, a first inner tube 111 disposed within the outer tube, and a second inner tube 112 disposed within the first inner tube 111. The first inner tube 111 is capable of sliding relative to the outer tube in an axial direction, and the second inner tube 112 is axially slidable relative to the first inner tube 111.

The support assembly further includes a first locking assembly 201. The first locking assembly 201 includes a locking sleeve 210 connected to one end of the outer tube 110, and a gap is defined between the locking sleeve 210 and the second inner tube 112. The first locking assembly 201 also includes a pressing assembly 211 connected to one end of the first inner tube 111. The pressing assembly 211 moves in conjunction with the first inner tube 111, and its inner wall closely contacts the second inner tube 112. A side wall of the pressing assembly 211 is embedded into the gap between the locking sleeve 210 and the second inner tube 112.

In the present disclosure, the telescopic tube assembly 100 serves as the core structure of the support assembly, primarily providing height adjustment and load-bearing capacity. The telescopic tube assembly 100 adopts a three-stage telescopic design, it includes an outer tube 110, a first inner tube 111 disposed within the outer tube, and a second inner tube 112 disposed within the first inner tube 111. The outer tube 110 can be made of high-strength aluminum alloy material, which not only ensures sufficient structural strength but also achieves an overall lightweight design. Its outer surface can be provided with anti-slip textures to enhance user comfort and stability during gripping. The first inner tube 111 can slide smoothly relative to the outer tube 110 in the axial direction, enabling first-stage telescopic adjustment. The first inner tube 111 can also be made of aluminum alloy or high-modulus carbon fiber composite material, reducing self-weight while maintaining good rigidity and bending resistance. The outer tube 110 and the first inner tube 111 are precisely processed to ensure an appropriate clearance fit, guaranteeing smooth and unobstructed sliding while avoiding noticeable shaking during the extension and retraction process. The second inner tube 112 is disposed inside the first inner tube 111 and can slide freely in the axial direction relative to the first inner tube 111, forming a second-stage telescopic adjustment mechanism.

The first locking assembly 201 undertakes the crucial locking function in the present disclosure and features a simple and compact structural design. The locking sleeve 210 is fixedly connected to one end of the outer tube 110 and can be made of high-strength engineering plastics or lightweight metal materials. It may be cylindrically shaped, with an inner diameter slightly larger than the outer diameter of the second inner tube 112, forming a certain annular gap. The pressing assembly 211 is securely connected to one end of the first inner tube 111 and moves synchronously with the first inner tube 111, and its inner wall fits closely with the second inner tube 112 to ensure stability during movement.

The outer side wall of the pressing assembly 211 can be designed as a tapered or gradually changing structure, enabling it to fit accurately into the annular gap between the locking sleeve 210 and the second inner tube 112. When the side wall of the pressing assembly 211 is fully embedded into the gap, a radial compressive force is generated through a wedge effect, thereby firmly locking the second inner tube 112 in place. Conversely, when the pressing assembly 211 is at least partially withdrawn from the gap, the radial compressive force is released, allowing the second inner tube 112 to slide freely to achieve an unlocked state.

In practical application scenarios, for example, when a photographer needs to adjust the height of the support assembly, the first driving member 301 can be operated to drive the first inner tube 111 to move in a first direction (e.g., a downward direction). This movement synchronously drives the pressing assembly 211, which is fixedly connected to the first inner tube 111, to move in the same direction, causing the tapered side wall of the pressing assembly 211 to gradually withdraw from the annular gap between the locking sleeve 210 and the second inner tube 112. As the pressing assembly 211 withdraws, its radial compressive force on the second inner tube 112 gradually decreases until the locked state is completely released.

After unlocking, the second inner tube 112 can slide freely under an external force. Such external force can be gravity (when the support leg is placed vertically) or a pushing/pulling force applied by the user to adjust the height. The user can slide the second inner tube 112 to a desired position according to shooting requirements, flexibly adjusting the support height. It is worth noting that even in the fully unlocked state, the second inner tube 112 will not suddenly slip due to looseness but instead maintains a moderate sliding resistance to ensure that the adjustment process is safe and controllable.

Once the second inner tube 112 is adjusted to the desired position, the user operates the operating component to reset the first driving member 301, driving the first inner tube 111 to move in an axial second direction (usually an upward direction). This movement drives the pressing assembly 211 to re-insert into the annular gap between the locking sleeve 210 and the second inner tube 112. As the insertion depth increases, the tapered side wall of the pressing assembly 211 gradually exerts a radial compressive force on the second inner tube 112, ultimately achieving a firm locking. Compared with traditional structures, the number of parts is significantly reduced, which greatly lowers the machining accuracy requirements for components and difficulty of assembly. Meanwhile, the linkage design of the pressing assembly 211 and the first inner tube 111 eliminates complex transmission mechanisms, reduces potential failure points, and improves the reliability and service life of the product.

In this embodiment, the simple axial movement of the first inner tube 111 can drive the pressing assembly 211 to move and enable the tapered side wall of the pressing assembly 211 to accurately fit into the reserved gap between the locking sleeve 210 and the second inner tube 112, thereby achieve a wedge locking effect. This not only realizes a stable and reliable locking function, but also simplifies the operation process and improves use convenience.

Further, compared with the complex locking assemblies commonly found in traditional support leg assemblies, the present embodiment eliminates a large number of components, such as threaded fasteners, spring clips, eccentric wheels, etc., resulting in a simpler and more compact overall structure. The reduction in components not only reduces the product weight and improves portability, but also significantly lowers the machining accuracy requirements for components and difficulty of assembly, making the product more durable and easier to maintain.

The beneficial effects of the technical solution of the present disclosure are as follows: the axial movement of the first inner tube 111 drives the pressing assembly 211 to move, enabling the side wall of the pressing assembly 211 to naturally fit into the reserved gap between the locking sleeve 210 and the second inner tube 112, thereby achieving a stable locking effect. This not only eliminates the complex parts found in traditional support legs, making the overall structure simpler and more compact, but also reduces the machining accuracy requirements for the parts. Meanwhile, due to the linkage between the pressing assembly 211 and the first inner tube 111, the assembly process of the entire support assembly becomes simple and intuitive, requiring no complicated assembly procedures, thus improving production efficiency and reducing manufacturing costs.

With reference to FIG. 4, in the present disclosure, the inner wall of the locking sleeve 210 and the outer wall of the pressing assembly 211 are both configured to be tapered.

In the present disclosure, the inner wall of the locking sleeve 210 is designed as an inwardly tapered structure, with its inner diameter gradually decreasing from the end connected to the outer tube 110 towards the end away from the outer tube 110, forming an obvious taper. Correspondingly, the outer wall of the pressing assembly 211 is also designed as a tapered structure, with its outer diameter gradually increasing from the end connected to the first inner tube 111 towards the end away from the first inner tube 111. These two cooperating tapered surfaces enable the pressing assembly 211 to generate a more uniform and controllable radial pressure when inserted into the gap between the locking sleeve 210 and the second inner tube 112.

The intention behind the double-taper design is to create a more ideal wedge locking effect. When the pressing assembly 211 is embedded in the gap, its tapered outer wall works in conjunction with the tapered inner wall of the locking sleeve 210 to convert axial movement into radial pressure, subjecting the second inner tube 112 to a more uniform circumferential pressure. This pressure distribution is more reasonable compared to a single-taper design, which avoids local stress concentration, improves the reliability and stability of locking, and also reduces the risk of material fatigue.

When user operates the first driving member 301 to drive the first inner tube 111 and the pressing assembly 211 to move axially, a progressive contact is formed between the tapered outer wall of the pressing assembly 211 and the tapered inner wall of the locking sleeve 210. This progressive contact makes the increase in locking force smoother, avoiding sudden changes during the locking process, and allows the user to perceive a linear change in resistance, providing more accurate feedback.

During the unlocking process, the double-taper design also exhibits significant advantages. When the pressing assembly 211 starts to withdraw from the gap, the locking force decreases steadily with the reduction in contact area, avoiding the “sudden release” phenomenon common found in traditional locking structures. This makes the unlocking process smoother and more controllable, prevents the second inner tube 112 from accidentally slipping due to sudden unlocking, and improves operational safety.

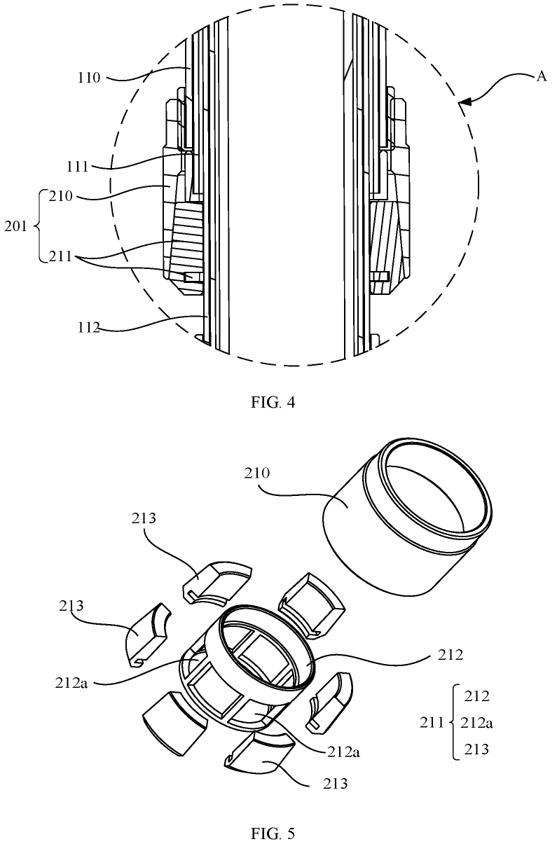

With continued reference to FIGS. 4 and 5, in the present disclosure, the pressing assembly 211 includes a first bushing 212 connected to one end of the first inner tube 111, and pressing blocks 213. A peripheral wall of the first bushing 212 defines a plurality of mounting notches 212a, and the plurality of mounting notches 212a are distributed at intervals along the circumferential direction of the first bushing 212. Each of the mounting notches 212a is arranged with at least one pressing block 213. The pressing blocks 213 are configured to abut against the second inner tube 112 under a resistance from the locking sleeve 210.

In the present disclosure, the pressing assembly 211 employs a split-type structure, which effectively improves the performance and reliability of the locking mechanism.

The first bushing 212, serves as a basic structural component of the pressing assembly 211, is securely connected to one end of the first inner tube 111 and moves axially along with the motion of the first inner tube 111. A plurality of mounting notches 212a is defined in the peripheral wall of the first bushing 212, and these notches are evenly spaced along the circumference of the first bushing 212, forming a regular annular layout. Each mounting notch 212a is arranged with at least one pressing block 213. These pressing blocks 213, as the key components that actually perform the locking function, play a core role in the locking process.

In this embodiment, a plurality of independent pressing blocks 213 are provided. Different from the traditional integral propping ring structure, the pressing blocks 213 in this embodiment adopt a separated arrangement. Each pressing block 213 can be independently mounted in the corresponding mounting notch 212a and can move freely within a certain range. This allows each pressing block 213 to independently abut against the second inner tube 112 under the resistance of the locking sleeve 210, forming a balanced multi-point distribution of locking force.

Consequently, the multiple independent pressing blocks 213 can better adapt to minor irregularities on the surface of the second inner tube 112. Even if the second inner tube 112 has slight ovality or surface machining errors, each pressing block 213 can independently adapt and provide effective locking force, significantly improving the reliability and stability of locking. Further, the design of independent pressing blocks 213 enables the locking force more uniformly distributed along the circumference of the second inner tube 112, avoiding the stress concentration that may occur with traditional integral propping rings, reducing the risk of deformation of the second inner tube 112, and also improving the locking strength.

In addition, the pressing blocks 213 can be made of specialized materials different from those used for the first bushing 212, such as high-strength nylon, polyurethane, or special engineering plastics. These materials have excellent frictional properties and wear resistance, enabling them to maintain stable locking performance over a long period. Meanwhile, using the pressing block 213 material with moderate hardness can provide sufficient locking force while avoiding scratches or damage to the surface of the second inner tube 112, extending the service life of the entire support assembly.

In actual operation, when the first inner tube 111 is driven by the first driving member 301 to move in the second axial direction, it drives the first bushing 212 and each pressing block 213 to move together until they enter the gap between the locking sleeve 210 and the second inner tube 112. As the pressing assembly 211 advances further, the inner wall of the locking sleeve 210 (when configured with the aforementioned tapered structure) exerts radial pressure on each pressing block 213, pushing the pressing blocks 213 to move inward and abut closely against the second inner tube 112. Since each pressing block 213 can move independently, it can automatically adjust its position and pressure distribution to ensure an optimal contact state with the second inner tube 112, thereby achieving a stable and reliable locking effect.

In addition, the design of independent pressing blocks 213 also facilitates maintenance and replacement. During long-term use, if any pressing block 213 is worn or damaged, it can be replaced individually without replacing the entire pressing assembly 211, which reduces maintenance costs.

In summary, the pressing assembly 211 in the embodiments adopts a split-type structural design featuring the first bushing 212 matching with multiple independent pressing blocks 213, which not only provides more uniform and reliable locking performance, but also demonstrates significant advantages in terms of manufacturing and maintenance.

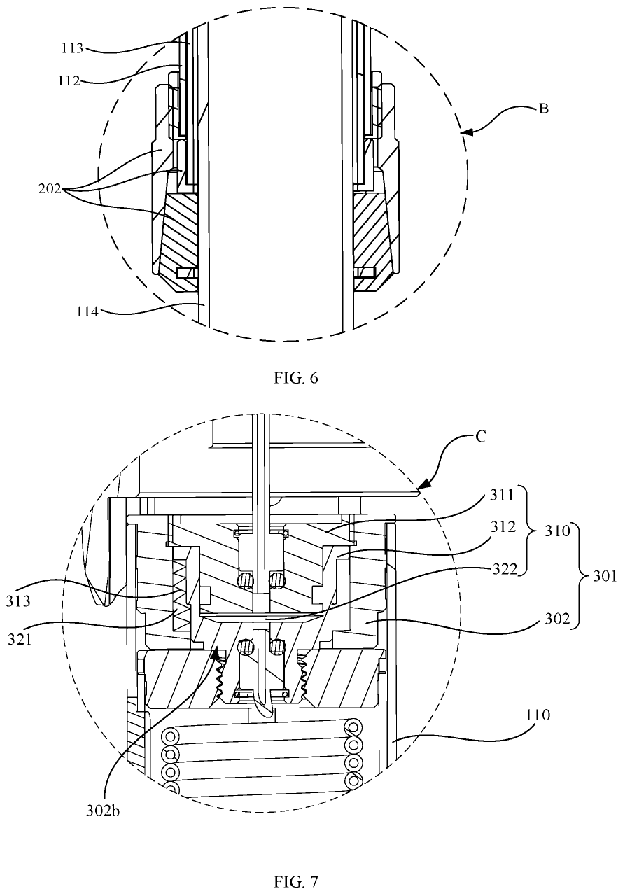

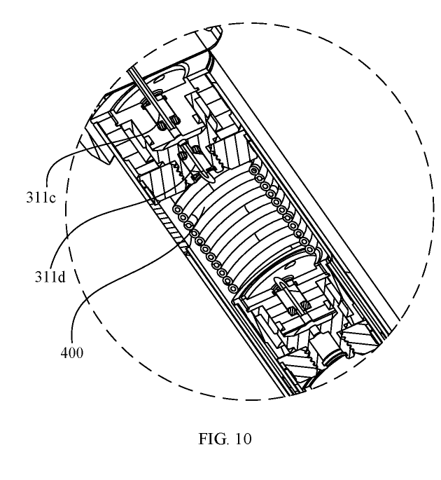

With continued reference to FIGS. 6 to 10, a third inner tube 113 and a fourth inner tube 114 which are sequentially nested are provided, and the third inner tube 113 is disposed within the second inner tube 112. The support assembly further includes a second locking assembly 202, which is arranged at one end of the second inner tube 112 and one end of the third inner tube 113, and the structure of the second locking assembly 202 is identical to that of the first locking assembly 201.

On the basis of the aforementioned technical solution, the present embodiment further expands the telescopic capacity of the support assembly. By adding the third inner tube 113 and the fourth inner tube 114, combined with the second locking assembly 202, a more flexible height adjustment function is achieved.

In the present embodiment, the telescopic tube assembly 100 of the support assembly adopts a more extensive multi-stage telescopic structure, including the outer tube 110, the first inner tube 111, the second inner tube 112, the third inner tube 113, and the fourth inner tube 114, which are sequentially nested together. Among them, the third inner tube 113 is slidably disposed inside the second inner tube 112, and the fourth inner tube 114 is slidably disposed inside the third inner tube 113. Each tube maintains a good sliding fit relationship with the others, collectively forming a complete four-stage telescopic system.

To ensure the stability and reliability of the multi-stage telescopic system, the present embodiment is also provided with the second locking assembly 202, which is installed at the connection between the second inner tube 112 and the third inner tube 113. It is worth noting that the structure of the second locking assembly 202 is completely identical to that of the aforementioned first locking assembly 201, adopting the same locking principle and mechanism design, including core components such as the locking sleeve 210 and the pressing assembly 211, thus achieving technical unity and consistency. The structural consistency not only simplifies the design process, but also realizes the generalization of components, significantly reduces the complexity of manufacturing and assembly.

The working principle of the second locking assembly 202 is basically the same as that of the first locking assembly 201. When it is necessary to adjust the extension lengths of the third inner tube 113 and the fourth inner tube 114, user can operate the driving mechanism of the second locking assembly 202 to withdraw the pressing assembly 211 from the gap between the locking sleeve 210 and the third inner tube 113, thereby releasing the locked state. At this time, the third inner tube 113 and the fourth inner tube 114 can slide freely to achieve position adjustment. After adjusting to the desired position, the user operates the driving mechanism again to insert the pressing assembly 211 into the gap, generating radial pressure, thus locking the position of the third inner tube 113.

In some embodiments, the operations for each locking assembly in the multi-stage telescopic system can be independent of each other. The user can choose to adjust the position of only one section of the tube, or to adjust multiple sections of tubes simultaneously, achieving more precise and diversified height control.

Furthermore, the accuracy of the clearance fit between the various tubes is crucial to the performance of the entire telescopic system. Excessively large clearance may cause shaking and instability, while excessively small clearance may affect smoothness of sliding. In the present embodiment, the clearance between the various tubes can be controlled within the range of 0.1 millimeter to 0.3 millimeter, which not only ensures sliding performance but also prevents excessive shaking.

In summary, by adding the third inner tube 113, the fourth inner tube 114, and the second locking assembly 202, the present embodiment achieves more flexible and diverse height adjustment functions on the aforementioned technical solution, improving the practicability and adaptability of the support assembly. The multi-stage telescopic design is suitable for application scenarios with high requirements for equipment height and angle, such as professional photography and film shooting.

With continued reference to FIGS. 7 to 10, in the present embodiment, the support assembly further includes a driving mechanism, and the driving mechanism includes a first driving member 301. The first driving member 301 is disposed at the other end of the outer tube 110, and an actuating end of the first driving member 301 extends into the outer tube 110 and is connected to the other end of the first inner tube 111. The first driving member 301 is configured to drive the first inner tube 111 to move.

In the present embodiment, the support assembly is equipped with a specialized driving mechanism, which mainly includes the first driving member 301. The first driving member 301 is disposed at the other end of the outer tube 110 (opposite to the end connected to the locking sleeve 210), and its actuating end extends into the outer tube 110 and is securely connected to the other end of the first inner tube 111, forming a direct mechanical transmission. By operating the first driving member 301, the user can control the axial movement of the first inner tube 111, enabling the adjustment of relative position between the pressing assembly 211 and the locking sleeve 210, and completing the locking or unlocking operation.

The first driving member 301 can be implemented using various technical methods based on different usage requirements and cost considerations. For example, in professional-grade supporting equipment, a micro hydraulic cylinder can be used as the first driving member 301, driving the first inner tube 111 by controlling the flow direction and pressure of hydraulic oil.

In mid-range products, a pneumatic component can be used as the first driving member 301, which uses compressed air to drive the piston to move and drive the first inner tube 111 to move. Pneumatic driving has the characteristics of rapid response and easy operation, while also has a lower cost compared to hydraulic system, making it suitable for applications under medium load conditions.

In actual operation, when user needs to adjust the height of the support leg, the user first operates the first driving member 301 to drive the first inner tube 111 to move in the first axial direction (usually the downward direction). This movement is transmitted through the first inner tube 111 to the pressing assembly 211 connected thereto, causing the pressing assembly 211 to withdraw from the gap between the locking sleeve 210 and the second inner tube 112, releasing the locked state.

At this time, the second inner tube 112 (and possibly the third inner tube 113 and the fourth inner tube 114) is in the unlocked state and can slide freely to adjust the height. After adjusting to the desired position, the user operates the first driving member 301 again to drive the first inner tube 111 to move in the second axial direction (usually the upward direction), driving the pressing assembly 211 to reinsert into the gap, restoring the locked state, and fixing the position of each inner tube.

By introducing the first driving member 301 as the core drive mechanism, the present embodiment effectively addresses the control issue related to locking and unlocking operations in the support assembly, making the operation of the entire system more convenient and reliable. The optional design of different types of driving members provides a variety of implementation pathways for the product, enabling the selection of the most suitable technical solution according to different market positioning and application scenarios.

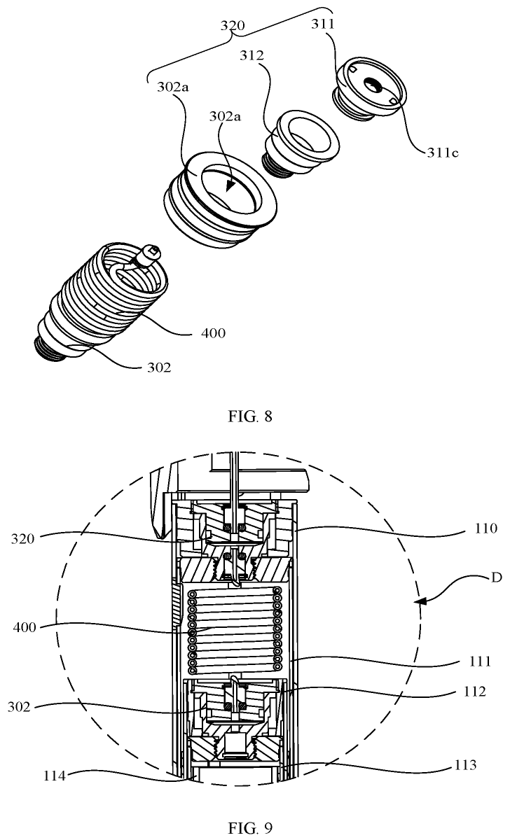

With reference to FIGS. 7 to 8, further, the first driving member 301 includes a mounting housing 302 and a piston assembly 310. A first opening 302a is defined in a top wall of the mounting housing 302, and a second opening 302b is defined in a bottom wall of the mounting housing 302. The piston assembly 310 includes a fixing seat 311 mounted in the first opening 302a and at least partially extends into a first cavity 321, and a piston sleeve 312 slidably disposed within the first cavity 321 and nested on a portion of the fixing seat 311 extending into the first cavity 321. A second cavity 322 for containing fluid is defined between the fixing seat 311 and the piston sleeve 312, and an end of the piston sleeve 312 facing away from the fixing seat 311 passes through the second opening 302b and is connected to one end of the first inner tube 111.

In the present embodiment, the first driving member 301 adopts a hydraulic piston structure mainly including the mounting housing 302 and the piston assembly 310. The mounting housing 302 is fixedly mounted at the end of the outer tube 110 and serves as the outer housing of the entire driving mechanism. The top wall of the mounting housing 302 is defined with the first opening 302a, and the bottom wall is defined with the second opening 302b, forming a first cavity 321 for accommodating the piston assembly 310 and working fluid.

The piston assembly 310 is the core component for realizing the hydraulic driving function, including the fixing seat 311, the piston sleeve 312, and the elastic member 313. The fixing seat 311 is mounted at the first opening 302a of the mounting housing 302, and a part of its structure extends into the first cavity 321. The piston sleeve 312 is slidably disposed in the first cavity 321 and nested on the portion of the fixing seat 311 extending into the first cavity 321, maintaining a good sliding fit relationship between the two. The space between the fixing seat 311 and the piston sleeve 312 defines the second cavity 322 for containing hydraulic fluid.

An end of the piston sleeve 312 facing away from the fixing seat 311 passes through the second opening 302b in the bottom wall of the mounting housing 302 and is securely connected to the end of the first inner tube 111, forming a direct mechanical transmission. When the pressure of the hydraulic fluid in the second cavity 322 changes, it acts directly on the piston sleeve 312 to drive it to move axially within the first cavity 321, thereby driving the connected first inner tube 111 to move synchronously.

To ensure reliable resetting of the system, the piston assembly 310 further includes an elastic member 313. The elastic member 313 is disposed within the first cavity 321 and is configured to elastically support the piston sleeve 312.

The elastic member 313 is arranged inside the first cavity 321 for elastically supporting the piston sleeve 312. The elastic member 313 may employ a compression spring structure, with one end abutting against the inner wall of the mounting housing 302 and the other end abutting against the piston sleeve 312. It is in a pre-compressed state for providing a continuous reset force for the piston sleeve 312.

In the locked state, the hydraulic fluid in the second cavity 322 maintains in a low-pressure state. The elastic member 313 pushes the piston sleeve 312 to move toward the first opening 302a, allowing the first inner tube 111 and the pressing assembly 211 to be in the locked position, where the second inner tube 112 is firmly locked.

When user needs to adjust the height of the support leg, high-pressure hydraulic fluid is injected into the second cavity 322 through an external control mechanism (such as a manual pump, electric pump, or pneumatic booster system). As the pressure in the second cavity 322 increases, the hydraulic pressure exerted on the piston sleeve 312 gradually exceeds the elastic force of the elastic member 313, pushing the piston sleeve 312 to move toward the second opening 302b and compressing the elastic member 313. This movement is transmitted to the first inner tube 111 through the piston sleeve 312 and causes the first inner tube 111 to move downward, and at the same time drives the pressing assembly 211 to withdraw from the gap between the locking sleeve 210 and the second inner tube 112, releasing the locked state.

At this time, the second inner tube 112 (and possibly the third inner tube 113 and the fourth inner tube 114) is in a free state and can be slidably adjusted. The user can adjust the support leg to the desired height as needed. After completing the height adjustment, the hydraulic pressure in the second cavity 322 is released (such as opening a pressure relief valve) to reduce the fluid pressure. Under the reset of the elastic member 313, the piston sleeve 312 automatically moves upward, driving the first inner tube 111 and the pressing assembly 211 back to the locked position, re-locking the second inner tube 112, and completing the entire adjustment process.

In some embodiments, the hydraulic fluid in the second cavity 322 may be specialized hydraulic oil or other low-pressure hydraulic media with good fluidity and stability. High-quality sealing rings can be used between the fixing seat 311 and the piston sleeve 312 to ensure the sealing performance of the hydraulic system. In addition, the elastic member 313 may be a compression spring made of stainless steel, and its elastic force shall be calculated to not only provide sufficient reset force but also avoid increasing the working pressure of the hydraulic system.

The piston sleeve 312 and the first inner tube 111 may be connected by threaded connection or snap-fit connection, which ensures reliable transmission and facilitates disassembly and maintenance when necessary. The mounting housing 302 and the outer tube 110 are also needed to be firmly and reliably connected, usually employing threaded connection or welding fixation.

Furthermore, the driving mechanism further includes a second driving member 320 linked to the first driving member 301. The second driving member 320 is disposed at one end of the second inner tube 112, and an actuating end of the second driving member 320 extends into the second inner tube 112 and is connected to one end of the third inner tube 113. The second driving member 320 is configured to drive the third inner tube 113 to move axially relative to the second inner tube 112. The structure of the second driving member 320 is identical to that of the first driving member 301.

In the present embodiment, the driving mechanism includes not only the aforementioned first driving member 301 but also the second driving member 320 linked to the first driving member 301. The second driving member 320 is disposed at one end of the second inner tube 112, and its actuating end extends into the second inner tube 112 and is directly connected to the end of the third inner tube 113. In this way, the second driving member 320 can drive the third inner tube 113 to move axially relative to the second inner tube 112, achieving locking control over the third inner tube 113 and possibly the connected fourth inner tube 114.

It is worth noting that the structure of the second driving member 320 is completely identical to that of the first driving member 301, also employing the core components such as the mounting housing 302 and the piston assembly 310 described in the aforementioned embodiments, resulting in structural unity and modular characteristics. This design not only simplifies the design and manufacturing processes but also improves the universality and maintainability of components.

When user operates the hydraulic control system, high-pressure hydraulic fluid is not only delivered into the second cavity 322 of the first driving member 301 but also transmitted to the corresponding cavity of the second driving member 320 through hydraulic pipelines. In this way, the two driving members can receive the same hydraulic signal simultaneously and perform synchronous actions.

During unlocking operation, as the hydraulic pressure increases, the piston sleeve 312 of the first driving member 301 pushes the first inner tube 111 to move downward, while the piston sleeve 312 of the second driving member 320 also pushes the third inner tube 113 to move downward. This synchronous movement enables the first locking assembly 201 and the second locking assembly 202 to release the locked state almost simultaneously, achieving one-button unlocking of all inner tubes. The user can smoothly adjust the extension length of each inner tube, completing the height adjustment of the support leg in a single operation.

Similarly, after the height adjustment is completed, the pressure of the hydraulic system is released, and the elastic members 313 in the two driving members simultaneously push their respective piston sleeves 312 to reset, driving the first inner tube 111 and the third inner tube 113 back to the locked position, locking all inner tubes at the same time, achieving one-button locking.

In some embodiments, to realize the linkage between the driving members, a specialized hydraulic linkage control system may also be equipped. For example, the system mainly consists of a hydraulic source (such as a manual pump or a micro electric pump), a distribution valve, a pressure balancing valve, and connecting pipelines. The pressure generated by the hydraulic source is evenly distributed to each driving member through the distribution valve, ensuring that the driving members receive the same driving force. The pressure balancing valve ensures that the driving members can maintain coordinated actions even if they are under different loads.

Furthermore, the control system can also integrate with electronic control components, such as solenoid valves and pressure sensors, to achieve more precise pressure control and action synchronization. The user can easily realize precise multi-stage telescopic control through a simple button or a touch control interface.

In the present embodiment, synchronous control of the multi-stage telescopic tubes of the support assembly is achieved through linked multi-stage drive, which improves the operational convenience and practicability of the product.

Further, a third opening 311c communicated with the second cavity 322 is defined in the fixing seat 311, and a fourth opening 311d communicated with the second cavity 322 is defined in one side wall of the piston sleeve 312.

The third opening 311c is configured for coupling with an operating component, and the fourth opening 311d is coupled to the second driving member 320 via a fluid pipeline 400.

In the present embodiment, a linkage mechanism for multi-stage drive is further provided, and hydraulic linkage between the driving members is realized through fluid path design and connection via the elastic fluid pipeline 400, making the operation of the multi-stage telescopic support leg more convenient and reliable.

The third opening 311c communicated with the second cavity 322 is defined in the fixing seat 311 of the first driving member 301. This opening can be designed as a standard hydraulic interface for connection with external operating components (such as a manual pump, electric pump, or pneumatic conversion device) and serves as the input port of the entire hydraulic system. Through this interface, the working medium can be directly injected into the second cavity 322 to provide driving force for the piston assembly 310.

Meanwhile, the fourth opening 311d coupled with the second cavity 322 is defined in one side wall of the piston sleeve 312. This opening serves as the output port of the hydraulic system and is coupled to the second driving member 320 via the fluid pipeline 400. This allows the first driving member 301 to be the main control unit of the system. The first driving member 301 not only receives control signals but also transmits the signals to the second driving member 320, achieving a linkage effect.

In addition, a special flexible fluid pipeline 400 can be used to connect the two driving members. For example, this pipeline can be designed as a spring-like structure, resembling a spiral spring made of metal or composite materials on the outside, but with a sealed hydraulic channel on the inside. In this way, the pipeline has excellent elastic expansion and contraction performance, allowing it to extend as the support leg extends and automatically retract when the support leg retracts, maintaining a neat appearance and good functionality.

The flexible fluid pipeline 400 can be configured as a pressure-resistant rubber inner tube combined with a stainless steel or high-strength synthetic fiber braided layer, ensuring good sealing performance and pressure resistance even under bending and in telescopic state. Based on the hydraulic linkage design, when the user inputs high-pressure liquid into the third opening 311c through an operating component (such as a hand pump, electric pump, or button-controlled solenoid valve), the pressure is first transmitted to the second cavity 322 of the first driving member 301, pushing the piston sleeve 312 to move downward, driving the first inner tube 111 and the pressing assembly 211 to move, and releasing the first-stage locking.

At the same time, this pressure is transmitted to the corresponding chamber of the second driving member 320 through the fourth opening 311d and the flexible fluid pipeline 400, driving the piston sleeve 312 of the second driving member 320 to move synchronously to release the locking of the third inner tube 113. This hydraulic transmission based linkage ensures a high degree of synchronization of the actions of the driving members at all stages, maintaining consistent response characteristics even under different load conditions.

After the height of the support leg has been adjusted, the pressure control on the operating component is released, the pressure of the hydraulic system decreases, and the elastic members 313 in each driving member simultaneously push the piston sleeves 312 to reset, achieving synchronous locking at all levels. The entire process is simple and intuitive, with all controls completed in a single operation.

In some embodiments, the third opening 311c and the fourth opening 311d can adopt a standardized hydraulic quick-coupling design, which ensures a secure connection while also facilitates disassembly and maintenance when needed. The outer diameter of the flexible fluid pipeline 400 can be reasonably designed according to the overall size of the support leg, for example, controlled within the range of 8 millimeter to 12 millimeter, which not only ensures sufficient flow but also does not affect the overall appearance.

To prevent the flexible pipeline from tangling or interfering during extension and retraction, the support leg can also be equipped with special guide grooves or fixing clips to ensure that the pipeline moves along a predetermined path. Meanwhile, a protective sleeve can be added to the outer layer of the pipeline to prevent accidental wear or scratches.

The hydraulic fluid in the system can be a specialized hydraulic oil with low viscosity and high stability, ensuring good fluidity and transmission efficiency under different temperature conditions. For products used in low-temperature environments, special low-temperature hydraulic oil can be selected to maintain system performance.

Through the innovative fluid linkage control design combined with the application of the flexible fluid pipeline 400, the present embodiment addresses the synchronous control issue of multi-stage telescopic support legs, and achieves excellent performance in terms of simple operation, rapid response, and precise adjustment. It not only improves the technical sophistication and user experience of the product, but also expands the breadth of its application scenarios, such as professional film and television shooting, stage lighting support, and other fields that demand high adjustment speed and accuracy.

The present disclosure further provides a photography support frame, including an operating component, a bearing seat, and a plurality of support assemblies according to the aforementioned embodiments. Since the photography support frame adopts all the technical solutions of all the aforementioned embodiments, it at least has all the technical effects brought by the technical solutions of the aforementioned embodiments, which will not be repeated here. The bearing seat is connected to the telescopic tube assemblies of the plurality of support assemblies, and the bearing seat is configured for mounting photographic equipment.

The operating component is connected to the driving mechanism of each support assembly, and the operating component is configured to output a driving force to the driving mechanism of each support assembly.

The photography support frame is mainly composed of three core parts: an operating component, a bearing seat, and a plurality of support assemblies. The support assemblies adopt the technical solutions in the aforementioned embodiments, including structures such as the multi-stage telescopic tube assembly 100, the locking assembly, and the driving mechanism.

The bearing seat is located at the top of the support frame and is securely connected to the telescopic tube assemblies 100 of the plurality of support assemblies, forming a stable support structure. The bearing seat is provided with standardized mounting interfaces for mounting various types of photographic equipment, such as cameras, video cameras, pan-tilts, and the like. The design of the bearing seat focuses on the balance between lightweight and strength, and the bearing seat can be made of high-strength aluminum alloy or carbon fiber composite material, ensuring sufficient support strength while minimizing the overall weight as much as possible.

The operating component is connected to the driving mechanism of each support assembly, and is configured to output control signals and driving force to the driving mechanism. According to the hydraulic drive solution adopted in the aforementioned embodiments, the operating component may be an integrated hydraulic control system, including a manual pump or an electric pump, a pressure control valve, distribution pipelines, and the like, which is capable of providing hydraulic driving force to multiple support assemblies simultaneously to achieve unified control.

In actual use, user may first mount the photographic equipment on the bearing seat, and then control the extension and locking of the support assemblies via the operating component. When it need to adjust the support height, the user operates the control system (e.g., pumping hydraulic oil or pressing an electric control button), and the driving force is transmitted to the driving mechanism of each support assembly through the connecting pipelines to release the locked state of each support leg synchronously.

The user can adjust the extension length of each support leg according to shooting requirements. After the adjustment is completed, the user releases the control device on the operating component, the driving force disappears, and the support assemblies automatically restore the locked state under the action of the elastic members 313, fixing the position and height of the entire support frame. The entire operation process is simple and intuitive, with the adjustment of all support legs completed by a single control, which improves work efficiency.

The above description is merely some embodiments. It should be noted that for one with ordinary skills in the art, improvements can be made without departing from the concept of the present disclosure, but these improvements shall fall into the protection scope of the present disclosure.

What is claimed is:

1. A support assembly, configured to support an equipment, comprising:
a telescopic tube assembly, comprising:
an outer tube;
a first inner tube, disposed within the outer tube and being capable of sliding relative to the outer tube in an axial direction; and
a second inner tube, disposed within the first inner tube and being capable of sliding relative to the first inner tube in the axial direction;
a first locking assembly, comprising:
a locking sleeve, connected to one end of the outer tube, a gap being defined between the locking sleeve and the second inner tube; and
a pressing assembly, connected to one end of the first inner tube, the pressing assembly moving in conjunction with the first inner tube, an inner wall of the pressing assembly being closely contacted the second inner tube, and a side wall of the pressing assembly being embedded into the gap between the locking sleeve and the second inner tube.

2. The support assembly according to claim 1, wherein an inner wall of the locking sleeve and an outer wall of the pressing assembly are both featured to be tapered.

3. The support assembly according to claim 2, wherein the pressing assembly comprises:
a first bushing, connected to the end of the first inner tube, a peripheral wall of the first bushing defining a plurality of mounting notches, and the plurality of mounting notches being spaced apart along a circumferential direction of the first bushing; and
a plurality of pressing blocks, each of the mounting notches being arranged with at least one pressing block;
wherein the pressing blocks are configured to abut against the second inner tube under a pressing action from the locking sleeve.

4. The support assembly according to claim 1, further comprising:
a third inner tube disposed within the second inner tube;
a fourth inner tube disposed within the third inner tube; and
a second locking assembly, disposed at one end of both the second inner tube and the third inner tube, wherein a structure of the second locking assembly is identical to that of the first locking assembly.

5. The support assembly according to claim 2, further comprising:
a third inner tube disposed within the second inner tube;
a fourth inner tube disposed within the third inner tube; and
a second locking assembly, disposed at one end of both the second inner tube and one end of the third inner tube, wherein a structure of the second locking assembly is identical to that of the first locking assembly.

6. The support assembly according to claim 3, further comprising:
a third inner tube disposed within the second inner tube;
a fourth inner tube disposed within the third inner tube; and
a second locking assembly, disposed at one end of both the second inner tube and one end of the third inner tube, wherein a structure of the second locking assembly is identical to that of the first locking assembly.

7. The support assembly according to claim 4, further comprising:
a driving mechanism, wherein the driving mechanism comprises:
a first driving member, disposed at the other end of the outer tube, the first driving member comprising an actuating end which is extended into the outer tube and is connected to the other end of the first inner tube, and the first driving member being configured to drive the first inner tube to move.

8. The support assembly according to claim 7, wherein the first driving member comprises:
a mounting housing, having a first cavity defined therein, a top wall of the mounting housing being defined with a first opening, and a bottom wall of the mounting housing being defined with a second opening; and
a piston assembly, wherein the piston assembly comprises:
a fixing seat, mounted at the first opening and at least partially extended into the first cavity; and
a piston sleeve, slidably disposed within the first cavity and nested over a part of the fixing seat that extends into the first cavity, and a second cavity for receiving fluid being defined between the fixing seat and the piston sleeve;
wherein an end of the piston sleeve opposite to the fixing seat passes through the second opening and is connected to the one end of the first inner tube.

9. The support assembly according to claim 8, wherein the piston assembly further comprises an elastic member disposed within the first cavity, and the elastic member is configured to flexibly support the piston sleeve.

10. The support assembly according to claim 7, wherein the driving mechanism further comprises:
a second driving member which moves in conjunction with the first driving member; wherein
the second driving member is disposed at the end of the second inner tube;
the second driving member comprises an actuating end that extends into the second inner tube and is connected to another end of the third inner tube; and
the second driving member is configured to drive the third inner tube to move axially relative to the second inner tube, wherein a structure of the second driving member is identical to that of the first driving member.

11. The support assembly according to claim 9, wherein:
the fixing seat defines a third opening communicated with the second cavity, and a side wall of the piston sleeve defines a fourth opening communicated with the second cavity; and
the third opening is configured to couple to an operating component, and the fourth opening is coupled to the second driving member via a fluid pipeline.

12. A photography support frame, comprising:
an operating component;
a bearing seat; and
a plurality of support assemblies according to claim 7;
wherein the bearing seat is connected to the telescopic tube assemblies of the plurality of support assemblies, and the bearing seat is configured to mount a photographic equipment; and
the operating component is connected to the driving mechanism of each of the support assemblies, and the operating component is configured to output a driving force to the driving mechanism of each of the support assemblies.

13. The photography support frame according to claim 12, wherein the first driving member comprises:
a mounting housing, having a first cavity defined therein, a top wall of the mounting housing being defined with a first opening, and a bottom wall of the mounting housing being defined with a second opening; and
a piston assembly, wherein the piston assembly comprises:
a fixing seat, mounted at the first opening and at least partially extended into the first cavity; and
a piston sleeve, slidably disposed within the first cavity and sleeved over a part portion of the fixing seat that extends into the first cavity, and a second cavity for receiving fluid being defined between the fixing seat and the piston sleeve;
wherein an end of the piston sleeve opposite to the fixing seat passes through the second opening and is connected to the end of the first inner tube.

14. The photography support frame according to claim 13, wherein the piston assembly further comprises an elastic member disposed within the first cavity, and the elastic member is configured to elastically support the piston sleeve.

15. The photography support frame according to claim 12, wherein the driving mechanism further comprises:
a second driving member which moves in conjunction with the first driving member; wherein
the second driving member is disposed at the end of the second inner tube;
the second driving member comprises an actuating end that extends into the second inner tube and is connected to an second end of the third inner tube; and
the second driving member is configured to drive the third inner tube to move axially relative to the second inner tube, wherein a structure of the second driving member is identical to that of the first driving member.

16. The photography support frame according to claim 14, wherein:
the fixing seat defines a third opening communicated with the second cavity, and a side wall of the piston sleeve defines a fourth opening communicated with the second cavity.
